(19) United States
(12) Patent Application Publication
(10) Pub. No.: US 2012/0259126 A1
(43) Pub. Date: Oct. 11, 2012

(54) LIPOPHILIC METALLATES

(75) Inventors: Bernd Straub, Heidelberg (DE); Michael Wrede, Heiligkreuz Weinheim (DE); Karen Schmid, Dossenheim (DE)

(73) Assignee: UNIVERSITAT HEIDELBERG, Heidelberg (DE)

(21) Appl. No.: 13/496,458

(22) PCT Filed: Sep. 14, 2010
(86) PCT No.: PCT/EP10/05626

§ 371 Date: Jun. 25, 2012

(30) Foreign Application Priority Data
Sep. 17, 2009 (EP) 10 2009 041 864.4

(51) Int. Cl. C07F 5/06; C07F 5/02

(52) U.S. Cl. 548/106; 549/210; 556/182; 568/6; 556/185

(57) ABSTRACT

The present invention relates to arylated, silylated and/or alkylated bis(2,2′-diphenolato)metallates and to a method for the production thereof.

The present invention relates to arylated, silylated and alkylated bis(2,2′-diphenolato)metallates, and to a process for preparation thereof.

Lipophilic anions refer to anions which have a good solubility in nonpolar solvents. Such anions at least partly have the properties of ideal anions, namely not only a good solubility in nonpolar solvents but also, more particularly, an inert molecule surface, weak coordination to cations, stability to thermal decomposition, stability to strong redox systems, and stability to acids and bases. Such lipophilic anions are employed in ionic liquids, as crystallization promoters or stabilizers, or as solvent superabsorbents. In addition, the inventive anions can be used as a catalyst or cocatalyst.

To date, chemical research in lipophilic anions has concentrated on weakly coordinating anions, i.e. on anions with a low coordination tendency and low nucleophilicity. For this purpose, essentially anions with fluorinated molecule surfaces, for example NaBArF, have been developed. However, such anions are comparatively costly and have poor biodegradability (are persistent) due to the fluoroorganic radicals present therein. In addition, during the synthesis of such fluorinated anions, toxic starting compounds are frequently used, or toxic or explosive intermediates are formed. Salts of fluorinated boron cluster anions are likewise explosive.

Borate ester anions have also already been described as lipophilic anions. For instance, chiral, polar borate ester anions have been synthesized in order to influence the enantioselectivity of cationic catalysts via the anion (cf. D. B. Llewellyn, B. A. Arndtsen, Organometallics 2004, 23, 2838). Borate esters based on catecholate are also known (cf. WO-A-2009/027541). But the underlying alkylated catechols here are not easy to obtain. Furthermore, catechols with long alkyl chains are known, for example, as toxic or allergenic constituents of poison ivy.

It is therefore an object of the present invention to provide lipophilic anions which can be produced in a simple and inexpensive manner and which should be nontoxic and biodegradable.

This object is achieved by the embodiments identified in the claims.

More particularly, anions with the general structure (I) are provided:

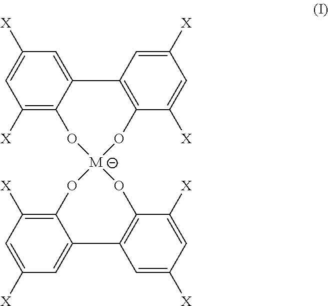

In the structure shown above, M is selected from the group consisting of Al, B, Ga, Sc, Y and the lanthanoids. Preferred lanthanoids are lanthanum, cerium, samarium, europium and ytterbium.

More preferably M is aluminum or boron. Compounds with Al as the central atom and a total of eight tert-butyl groups are called altebates by the applicant, and analogous compounds with B as the central atom bortebates.

X is a substituent selected independently from the group consisting of aryl, —SiR¹¹R¹²R¹³ and substituents with the following general structure (II-A) or (II-B):

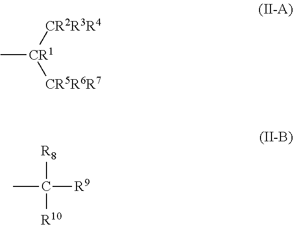

where R¹, R², R³, R⁴, R⁵, R⁶, and R⁷ are each independently selected from the group consisting of hydrogen, straight- or branched-chain C₁₋₁₂-alkyl, phenyl and benzyl, and R⁸, R⁹ and R¹⁰ are each independently selected from the group consisting of straight- or branched-chain C₁₋₁₈-alkyl, phenyl and benzyl. There may also be overlaps between the structures (II-A) and (II-B).

In a preferred embodiment, X is a substituent with the general structure (II-B) where R⁸, R⁹ and R¹⁰ are each independently selected from a straight- or branched-chain C₁₋₂₆-alkyl radical.

When X is a substituent having the general structure (II-A), R¹ is preferably selected from hydrogen and methyl.

More preferably, X is a —CMe₃, —CEt₃, —Ciso-Pr₃, —CPr₃, —CBu₃, —Ciso-Bu₃, —CMe₂C₁₅H₃₁, —CMe₂C₁₇H₃₃, —CMe₂C₁₇H₃₅, —CEt₂C₁₅H₃₁, —CEt₂C₁₇H₃₃, —CEt₂C₁₇H₃₅, —CBu₂C₁₅H₃₁, —CBu₂C₁₇H₃₃, —CBu₂C₁₇H₃₅ or a —CMe₂CH₂CMe₃ group.

The substituent X may likewise be aryl. In the context of the present invention, an aryl substituent is understood to mean a phenyl group in which one or more hydrogen atoms may be replaced by substituents. These substituents may each independently be selected from the group consisting of straight- or branched-chain C₁₋₁₈-aklyl, a C₁₋₆-thioalkyl group, a C₃₋₇-cycloalkyl group which may contain one or more heteroatoms, a C₁₋₆-alkoxy group, a C₁₋₆-dialkylamino group, a C₁₋₆-alkoxycarbonyl group and a hydroxyl group.

The substituent X may likewise be —SiR¹¹R¹²R¹³. R¹¹, R¹² and R¹³ here are each independently selected from the group consisting of aryl and straight- or branched-chain C₁₋₁₂-alkyl. The aryl group is as defined above. The —SiR¹¹R¹²R¹³ group is preferably selected from —Si(methyl)₃, —Si(tert-butyl)(methyl)₂, —Si(tert-butyl)₂(methyl), —Si(tert-butyl)₃ and —Si(phenyl)₃.

In a preferred embodiment, all substituents X are identical. This is advantageous with regard to a simple and efficient synthesis. It is particularly preferable that all substituents X are a tertiary carbon group, for example tert-butyl group. More preferably, the inventive anion has the following structure (III):

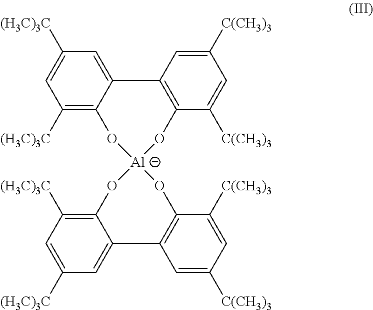

However, it is also possible that the four ortho and para substituents in each case are different.

The present invention further relates to compounds or salts which comprise an anion of the general structure (I) shown above and a cation. The cation may be any suitable cation.

The cation is preferably selected with regard to the respective use of the compound. The cation is not restricted to cations with a positive charge, but may also have charges such as +2, +3, +4, etc. The compounds may then have, for example, the following formulae: (cation)⁺(anion)⁻, (cation)²⁺((anion)⁻)₂, (cation)³⁺[(anion)⁻]₃, (cation)⁴⁺[(anion)⁻]₄, . . . (cation)ⁿ⁺[(anion)⁻]ₙ. n here may be in the range from 1 to 10 000. It is also possible to provide mixed salts with different anions, for example (cation)²⁺[(altebate)⁻(tosylate)⁻].

Suitable cations are, for example, metal cations selected from the group consisting of Li, Na, K, Rb, Cs, Mg, Ca, Sr, Ba, Sc, Y, La, Ti, Zr, V, Nb, Ta, Zn, Al, Ga, In, Ge and Bi. Suitable cations can, however, also be selected from the group consisting of H⁺, monosubstituted imidazolium derivatives such as 1-methylimidazolium, disubstituted imidazolium derivatives such as 1,3-dimethylimidazolium, 1-ethyl-3-methylimidazolium, 1-butyl-3-methylimidazolium, 1-propyl-3-methylimidazolium, 1-hexyl-3-methylimidazolium, 3-methyl-l-octylimidazolium, 1-decyl-3-methylimidazolium, 1-dodecyl-3-methylimidazolium, 3-methyl-1-tetradecylimidazolium, 1-hexadecyl-3-methylimidazolium, 1-octadecyl-3-methylimidazolium, 1-benzyl-3-methylimidazolium, 1-phenylpropyl-3-methylimidazolium, trisubstituted imidazolium derivatives such as 1,2,3-trimethylimidazolium, 1-ethyl-2,3-dimethylimidazolium, 1-butyl-2,3-dimethylimidazolium, 1-propyl-2,3-dimethylimidazolium, 1-hexyl-2,3-dimethylimidazolium, 1-hexadecyl-2,3-dimethylimidazolium, pyridinium derivatives such as N-ethylpyridinium, N-butylpyridinium, N-butyl-3,4-dimethylpyridinium, N-butyl-3,5-dimethylpyridinium, N-butyl-3-methylpyridinium, N-butyl-4-methylpyridinium, N-hexylpyridinium, N-octylpyridinium, 1-ethyl-3-hydroxymethylpyridinium, pyrrolidinium derivatives such as 1,1-dimethylpyrrolidinium, 1-ethyl-1-methylpyrrolidinium, 1,1-dipropylpyrrolidinium, 1,1-dibutylpyrrolidinium, 1-butyl-1-methylpyrrolidinium, 1,1-dihexylpyrrolidinium, 1-hexyl-1-methylpyrrolidinium, 1-methyl-1-octylpyrrolidinium, phosphonium derivatives such as tetrabutylphosphonium, trihexyl(tetradecyl)phosphonium, ammonium derivatives such as tetramethylammonium, tetraethylammonium, tetrabutylammonium, methyltrioctylammonium, ethyldimethylpropylammonium, cyclohexyltrimethylammonium, ethanolammonium, guanidinium derivatives such as guanidinium, N,N,N′,N′-tetramethyl-N″-ethylguanidinium, N,N,N′,N′,N″-pentamethyl-N″-propylguanidinium, N,N,N′,N′,N″-pentamethyl-N″-isopropylguanidinium, hexamethylguanidinium, isouronium derivatives such as O-methyl-N,N,N′,N′-tetramethylisouronium, S-ethyl-N,N,N′,N′-tetramethylisothiouronium, sulfonium derivatives such as diethylmethethylsulfonium, and combinations thereof. Ammonium cations may also be based on polystyrenes or polyacrylate esters. One example of such a polystyrene-based cation is shown below.

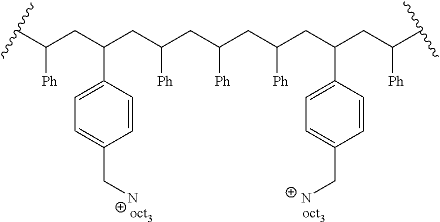

One example of a cation based on polyacrylate ester is the following cation:

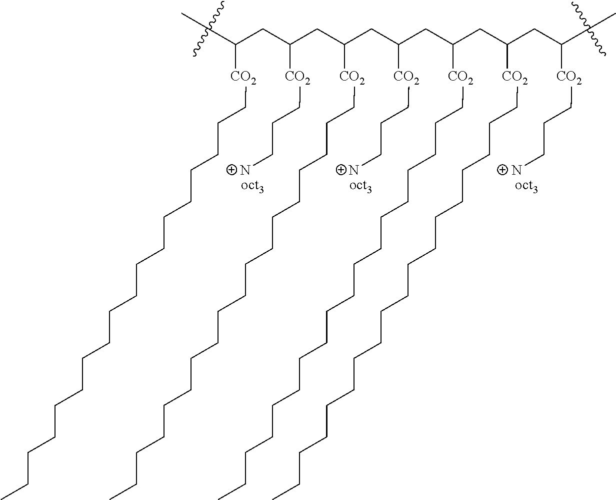

The cation is more preferably selected from the group consisting of Li and Na.

By simple salt metathesis reactions, it is possible, however, for example, to replace the alkali metal cations with more lipophilic cations, for example any phosphonium cations.

The present invention further relates to a process for preparing the anion with the general structure (I), which comprises the steps of:
(a) the oxidative coupling of a substituted phenol of the general structure (IV) or the alkylation of 2,2′-biphenol (V) to give a substituted biphenol of the general structure (VI), and
(b) the reacting of the biphenol of the general structure (VI) with a mixed metal hydride, with elemental metal, with metal alloys or by reaction with a base and a metal halide in order to form the anion with the general structure (I),
   where M and X in the general structures (IV), (VI) and (I) are each as defined above:

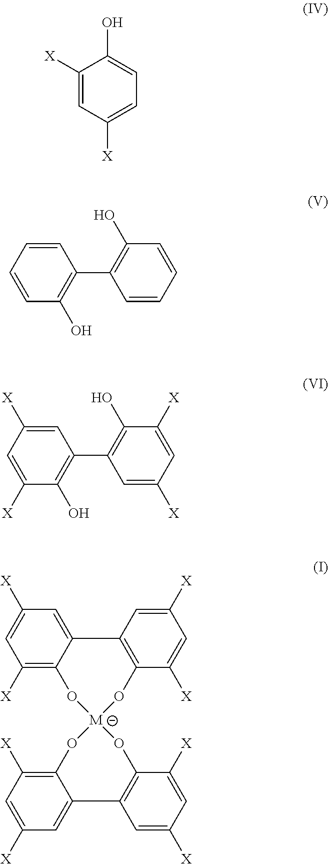

In the above process, in step (a), a substituted biphenol of the general structure (VI) is first prepared. This can firstly be effected by oxidative coupling of a substituted phenol of the general structure (IV). Some phenols of the general structure (IV) are commercially available. Processes for synthesizing phenols of the general structure (IV) are additionally known to those skilled in the art. Suitable processes for oxidative coupling are likewise known to those skilled in the art. This can be effected, for example, using MnO₂ as an oxidizing agent under air. Secondly, the substituted biphenol of the general structure (VI) can be obtained by alkylating 2,2′-biphenol (V). Corresponding alkylation reactions are known to those skilled in the art.

In step (b) of the process according to the invention, the biphenol of the general structure (VI) is then reacted with a mixed metal hydride or with a metal halide, for example BF₃, in combination with a base, in order to form the anion with the general structure (I). For this purpose, preference is given to using an aluminum hydride or a borohydride, e.g. LiAlH₄, NaAlH₄, NaBH₄ or LiBH₄. The reaction can be effected in any suitable solvent. Preference is given to performing the reaction in tetrahydrofuran or diethyl ether. In this case, the process according to the invention, after step (b), further comprises the step of thermal removal of the tetrahydrofuran or diethyl ether. This thermal removal is preferably effected under reduced pressure, which is advantageous with regard to the halide abstraction capacity of the anion.

The inventive anions exhibit many of the properties desired for anions, without needing to have fluorinated ligands. The screening of the reactive positions of the anion is achieved in the inventive system through the high steric demands of the four or eight aryl groups or secondary or tertiary alkyl groups. Furthermore, these bulky substituents lead to a distinct increase in solubility of the inventive compounds in very nonpolar solvents such as pentane.

For example, lithium tetrakis(tetrahydrofuran)bortebate, i.e. lithium tetrakis(tetrahydrofuran)bis(3,3′,5,5′-tetra-tert-butyl-2,2′-diphenolato)borate(III), in pentane exhibits a solubility in maximum concentrations of at least 21 g/L at 24° C. The corresponding altebate, i.e. lithium tetrakis(tetrahydrofuran)bis(3,3′,5,5′-tetra-tert-butyl-2,2′-diphenolato)aluminate(III) exhibits a solubility in pentane of 7 g/L at 24° C.

These values for compounds selected by way of example demonstrate the high solubility of the inventive anions or salts thereof in hydrocarbons.

Furthermore, the inventive compounds are inexpensive to prepare on a large scale, and so a majority of the applications which are performable with the inventive anions can be implemented both less expensively and in an environmentally friendlier manner compared to conventional anions.

A further advantageous property of the inventive anions is the high tendency to form single crystals with large cations, as a result of which the structure of the respective cations can easily be made accessible by an X-ray structure analysis.

The present invention further relates to the use of the above-described compounds which comprise the inventive anion and a cation as an ionic liquid, as an abstraction medium for halides or pseudohalides, as a crystallization promoter or stabilizer or as super absorbents, i.e. highly swellable polymers, for organic solvents. In addition, the inventive anions can be used as a catalyst or cocatalyst, as a phase transfer catalyst or for increasing the solubility of cations in organic solvents. These individual applications of the inventive anion are to be explained in detail hereinafter:

For example, the inventive anions can be used as an anion in an ionic liquid. Ionic liquids having a low volatility at room temperature (RTIL) have now become common reaction media which facilitate the removal of products (cf. H. Weingartner, Angew. Chem. Int. Ed. 2008, 47, 654). In the context of the present invention, particularly the basic properties of the anions are of interest, since the conjugated acid thereof can serve as a proton transporter to heterogeneous bases such as sodium carbonate. In the case, for example, of copper- or palladium-catalyzed cross-coupling reactions, stoichiometric amounts of hydrogen halide formed have to be neutralized in order to achieve a complete conversion. The use of toxic solvents such as dimethylformamide can be avoided by the use of ionic liquids.

Furthermore, the inventive anions can be used as a crystallization promoter or stabilizer. In fundamental chemical research, cationic compounds are frequently studied with the aid of NMR spectroscopy and of single-crystal x-ray structure analysis, for example in the isolation of catalysis intermediates. The corresponding anions should be inexpensive, lipophilic, in order to be soluble at least in some solvents, and symmetrical in order to have a high tendency to crystallization, and should have only few different hydrogen and carbon atoms in order to give easily interpretable NMR spectra. Both the inventive borates and the inventive aluminates meet these conditions, in contrast to the conventionally used tetrafluoroborates which have low lipophilicity, hexafluorophosphates which are hydrolysis-sensitive, perchlorates which are an explosion risk, tetraphenylborides (sodium salt: “Kalignost”), or the very expensive and persistent fluorinated derivatives of tetraphenyl boride BarF²⁰ and BarF²⁴.

In addition, the inventive anions can be used in superabsorbents for organic solvents. Superabsorbents, i.e. swellable polymers which can absorb several times their mass of liquid, have to date been restricted to water and hence to products such as diapers and soil improvers. Efficient superabsorbents are now also known for weakly polar solvents (cf. T. Ono, T. Sugimoto, S. Shinkai, K. Sada, Nature Materials 2007, 6, 429). However, no suitable superabsorbents are known yet for nonpolar solvents. Building on the known polyacrylate ester systems with 5% side chains having quaternary ammonium cations, the inventive lipophilic anions can be used as a counterion, and thus serve as superabsorbents for nonpolar solvents. For this purpose, preference is given to using the following ion based on polyacrylate as a cation:

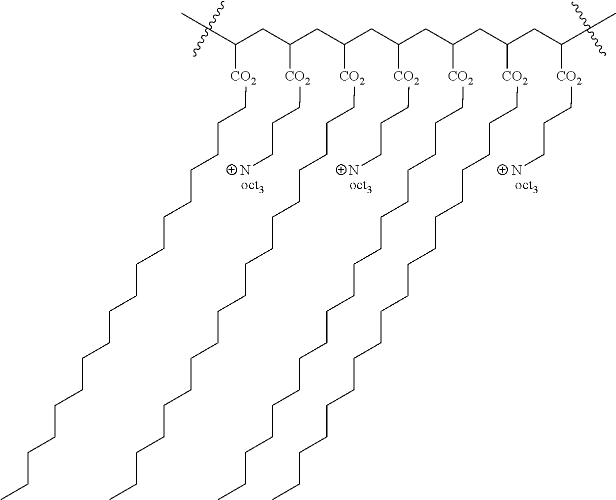

Such electrolyte gels (EGs) with the inventive lipophilic anions exhibit much better swelling performance compared to non-ionic gels (NGs). The improved absorption characteristics of these electrolyte gels (EGs) with the inventive lipophilic anions may be based on the osmotic pressure caused by the weakly coordinating anions or on the lowering of the glass transition temperature of the polymer by the quaternary ammonium cations bonded to the polymer and the lipophilic anions. For instance, swelling experiments with the aforementioned polyacrylate cation and altebate as a counterion or anion in, for example, THF, CHCl₃, CH₂Cl₂ or 1,2-C₂H₄Cl₂ show much improved swelling values. This property has also been found in swelling experiments with diesel fuel.

Furthermore, the inventive anions can be used as abstraction media for halides or pseudohalides. For example, a salt which comprises inventive anions and alkali metal cations with low coordination number, for example Na(thf)⁺, can abstract chloride from silver(I) and gold(I) complexes. It is likewise possible to abstract the chloride from tritylium chloride to form a tritylium cation. In this way, the inventive anions can be used as an activator for catalyst systems, by generating the catalytically active species by halide abstraction from the catalyst precursor.

In addition, the inventive cations or compounds thereof can be used as a catalyst or cocatalyst. For instance, it is possible to combine both sterically demanding cations and cationic metal complexes, such as NHC-gold(I) complexes, with the inventive anions. This opens up numerous possible uses for organic synthesis and catalysis. Examples are zirconocene cations which can be used together with lipophilic anions in alkene polymerization. Particularly in supercritical media such as CO₂ or ethene, the inventive lipophilic anions are advantageous for dissolution of the cationic catalysts in the supercritical phase.

The present invention is to be illustrated in detail hereinafter by examples, but without being restricted thereto.

### EXAMPLES

### 1. Synthesis of 3,3′,5,5′-tetra-tert-butylbiphenyl-2,2′-diol

A round-bottom flask was charged with 50 g (0.24 mol) of 2,4-di-tert-butylphenol and 31 g (88% pure, 0.31 mol) of manganese dioxide. The solids were suspended in 400 mL of heptane. The mixture was heated to boiling under reflux for 16 h (at least 3 h absolutely necessary). After checking the reaction (GC: 95% conversion), the suspension was filtered through Celite® and washed with CH₂Cl₂. Removal of the solvent gave a brown crude product. After recrystallization with acetic acid, 42.1 g (0.1 mol, 85% yield) of colourless crystals were obtained.

¹H NMR (CDCl₃, 300.13 MHz) δ_{H} (ppm)=7.41 (d, 2H, ⁵J_{H,H}=2.4 Hz), 7.31 (d, 2H. ⁵J_{H,H} =2.4 Hz), 5.23 (bs, 2H), 1.47 (s, 18H), 1.34 (s, 18H); ¹H NMR (d₈-THF, 250.13 MHz) δ_{H} (ppm)=7.29 (m, 2H), 7.06 (d, 2H, ⁵J(¹H, ¹H)=5.0 Hz), 1.42 (s, 18H), 1.27 (s, 18H); ¹³C{¹H} NMR (CDCl₃, 75.48 MHz) δ_{c} (ppm)=149.8, 143.0, 136.2, 125.3, 124.8, 122.3, 35.2, 34.5, 31.6, 29.7; m.p.: 204° C.; IR (KBr): □ (cm⁻¹)=3525, 3960, 2908, 2807, 1476, 1436, 1402, 1391, 1363, 1333, 1282, 1267, 1235, 1200, 1170, 1134, 1094, 883, 815, 770; anal. calculated (%) for C₂₈H₄₂O₂: C 81.90; H 10.31; 0 7.79; found: C 82.13; H 10.50; MS (ESI⁺) m/z (%): 410.5 (25) [M+H]⁺, 409.5 (100) [M]⁺

### 2. Synthesis of lithium tetrakis(tetrahydrofuran)bis(3,3′,5,5′-tetra-tert-butyl-2,2′-diphenolato)aluminate(III)

Under inert gas conditions, 110 mg (2.90 mmol) of LiAlH₄ were dissolved in 5 mL of THF which have been obtained by distillation of Na/Ph₂CO. A solution of 2.38 g (5.80 mmol) of 3,3′-5,5′-tetra-tert-butyl-2,2′-biphenol in 5 mL of THF was added gradually until no further H₂ evolution occurred. The removal of the solvent under reduced pressure gave a quantitative amount of a colourless powder.

¹H NMR (d₈-THF, 300.13 MHz) δ_{H}=7.06 (d, 4H, ⁴J_{H,H}=2.5 Hz), 6.88 (d, 4H, ⁴J_{H,H}=2.5 Hz), 1.25 (s, 36H), 1.24 (s, 36H); ¹H NMR (CDCl₃ 250.13 MHz) δ_{H}=7.29 (d, 4H, ⁴J_{H,H}=2.5 Hz), 7.06 (d, 4H, ⁴J_{H,H}=2.5 Hz), 1.33 (s, 36H), 1.28 (s, 36H); ¹³C{¹H} NMR (d₈-THF, 75.476 MHz) δ_{c}=158.33, 139.96, 138.99, 134.84, 129.74, 122.98, 37.16, 35.94, 33.73, 32.56; m.p.: 197° C.; IR (KBr): □ (cm⁻¹)=3419, 2960, 2906, 2863, 1640, 1464, 1431, 1405, 1387, 1360, 1284, 1242, 1200, 1100, 1049, 917, 874, 802, 783, 769, 683, 606; anal. calculated (%) for C₇₂H₁₁₂AlLiO₈: C 75.89; H 9.91; found: C 75.53; H 9.82; MS (ESI) m/z (%): 843.6 (100) [M⁻].

### 3. Synthesis of sodium bis(3,3′,5,5′-tetra-tert-butyl-2,2′-diphenolato)aluminate(III) (thf)₄₋₆

Under inert gas conditions, 270 mg (5.11 mmol) of NaAlH₄ were dissolved in 15 mL of THF. A solution of 4.41 g (10.7 mmol) of 3,3′,5,5′-tetra-tert-butyl-2,2′-biphenol in 5 mL of THF was added gradually until no further evolution of gas occurred. The reaction mixture was stirred at RT for 1 h. The removal of the solvent under reduced pressure gave a quantitative amount of a colourless powder.

¹H NMR (C₆D₆, 250.13 MHz) δ_{H} (ppm)=7.54 (d, 4H, ⁴J_{H,H}=2.4 Hz), 7.33 (d, 4H, ⁴J_{H,H} =2.2 Hz), 1.56 (s, 36H), 1.36 (s, 36H); ¹H NMR (CDCl₃, 250.13 MHz) δ_{H} (ppm)=7.26 (d, 4H, ⁴J_{H,H} =2.0 Hz), 7.05 (d, 4H, ⁴J_{H,H}=1.7 Hz), 1.31 (s, 36H), 1.26 (s, 36H); ¹³C{¹H} NMR (CDCl₃/d₆-DMSO, 75.46 MHz) δ_{c} (ppm)=149.9, 143.3, 138.4, 132.6, 126.2, 124.4, 35.5, 34.7, 34.4, 32.3, 32.0; m.p.: >305° C.; IR (KBr): □ (cm⁻¹)=3452, 2960, 2906, 2870, 1465, 1433, 1405, 1389, 1361, 1282, 1243, 1201, 1100, 877, 849, 802, 783, 768, 682, 682, 607; anal. calculated (%) for C₇₆H₁₂₀AlNaO₉: C 74.35; H 9.85; found: C 74.18; H 9.52; MS (ESI−) m/z (%): 834.71 (100), 844.61 (60), 845.70 (19)[M−Na]⁻

### 4. Sodium bis(3,3′,5,5′-tetra-tert-butyl-2,2′-diphenolato)aluminate(III) (thf)₁

Na(thf)altebate was obtained by THF elimination from the product described in point 3 above at 120° C. and 1 mbar for four days. Under these conditions, any excess of 3,3′,5,5′-tetra-tert-butylbiphenyl-2,2′-diol precursor compound used additionally sublimes.

¹H NMR (d₆-acetone, 300.13 MHz) δ_{H} (ppm)=7.18 (d, 4H, ⁴J_{H,H}=3.7 Hz), 6.97 (d, 4H, ⁴J_{H,H}=3.7 Hz), 3.64 (m, <4H, THF-H), 1.80 (m, <4H, THF-H), 1.31 (s, 36H), 1.31 (s, 36H); ¹³C{¹H} NMR (d₆-acetone, 75.47 MHz) δ_{c} (ppm)=156.8, 138.7, 138.4, 133.5, 128.4, 122.0, 68.1 (THF), 35.8, 34.6, 33.2, 31.2; decomposition 261° C.; IR (KBr): □ (cm⁻¹)=3528, 3414, 2961, 2907, 2870, 1644, 1464, 1431, 1405, 1389, 1361, 1282, 1242, 1201, 1099, 875, 802, 782, 769, 683, 606.

### 5. Synthesis of 1,3-bis(2,6-dlisopropylphenyl)imidazolinium altebate

Under inert gas conditions, 300 mg (0.7 mmol) of 1,3-bis(2,6-diisopropylphenyl)imidazolinium chloride were dissolved in 20 mL of CH₂Cl₂. While stirring, 825 mg (0.7 mmol) of lithium bis(3,3′,5,5′-tetra-tert-butyl-2,2′-diphenolato)aluminate(III).4THF in 20 mL of CH₂Cl₂ were added. A colourless precipitate formed (LiCl). The suspension was filtered through Celite® and washed with CH₂Cl₂. Removal of the solvent gave a colourless product in quantitative yield.

¹H NMR (CDCl₃, 300.13 MHz) δ_{H} (ppm)=7.53 (t, 2H, ³J_{H,H}=7.8 Hz), 7.38 (s, 1H), 7.28 (s, 4H), 7.13 (d, 4H, ⁴J_{H,H}=2.6 Hz), 7.00 (d, 4H, ⁴J_{H,H}=2.6 Hz), 3.77 (s, 4H), 3.49 (q, Et₂O), 3.73 (sept., 4H, ³J_{H,H}=6.8 Hz), 1.10-1.50 (m); ¹³C{¹H} NMR (CDCl₃, 75.47 MHz) δ_{c} (ppm)=157.5, 156.2, 146.2, 138.7, 138.2, 132.5, 132.3, 129.2, 128.0, 125.7, 122.1, 66.2, 54.1, 35.5, 34.4, 32.2, 30.8, 29.5, 25.9, 24.1, 15.7; m.p.: >300° C.; IR (KBr): □ (cm⁻¹)=3435, 2960, 2870, 1634, 1464, 1431, 1405, 1387, 1359, 1325, 1281, 1243, 1200, 1100, 874, 803, 783, 769, 683, 607; anal. calculated (%) for C₈₇H₁₂₉AlN₂O₅: C 79.77; H 9.93; N 2.14, found: C 79.55, H 9.86, N 2.01; HR-MS (ESI−) m/z (%): 843.58400 (100), 844.58738 (60), 845.59074 (19) [M]⁻ (ESI+) m/z (%): 391.31072 (100)

### 6. Synthesis of 1,3-bis(2,4,6-trimethylphenyl)imidazolinium altebate

Under inert gas conditions, 300 mg (0.9 mmol) of 1,3-bis(2,4,6-trimethylphenyl)imidazolinium chloride were dissolved in 20 mL of CH₂Cl₂. While stirring, 1.03 g (0.9 mmol) of lithium bis(3,3′,5,5′-tetra-tert-butyl-2,2′-diphenolato)aluminate(III).4THF in 20 mL of CH₂Cl₂ were added. A colourless precipitate formed (LiCl). The suspension was filtered through Celite® and washed with CH₂Cl₂. Removal of the solvent gave a colourless product in quantitative yield.

¹H NMR (CDCl₃, 300.13 MHz) δ_{H} (ppm)=7.44 (s, 1H), 7.13 (d, 4H, ⁴J_{H,H}=2.6 Hz), 6.99 (d, 4H, ⁴J_{H,H}=2.6 Hz), 6.96 (s, 4H), 3.76 (s, 4H), 3.49 (q, Et₂O), 2.31 (s, 6H), 2.16 (s, 12H), 1.10-1.50 (m, alkyl range); ¹³C{¹H} NMR (CDCl₃, 75.47 MHz) δ_{c} (ppm)=156.1, 141.1, 138.6, 138.3, 134.8, 132.6, 130.7, 129.9, 128.3, 125.7, 125.2, 122.1, 52.0, 35.5, 34.5, 32.3, 32.1, 30.8, 30.1 21.4, 18.1, 15.7; m.p.: >300° C.; IR (KBr): □ (cm⁻¹)=3436, 2952, 2905, 2868, 1632, 1463, 1431, 1404, 1387, 1359, 1281, 1242, 1200, 1100, 873, 803, 783, 769, 683, 607; anal. calculated (%) for C₈₁H₁₁₇AlN₂O₅: C 79.37; H 9.62; N 2.29, found: C 79.20, H 9.67, N 2.18.

### 7. Synthesis of trityl altebate

A schlenk flask was charged with 50 mg (0.2 mmol) of trityl chloride dissolved in 5 mL of absolute CH₂Cl₂. Subsequently, a solution of 200 mg (0.2 mmol) of sodium bis(3,3′,5,5′-tetra-tert-butyl-2,2′-diphenolato)-aluminate(III).1THF in 5 mL of CH₂Cl₂ was added. An immediate color change from colourless to red/orange was observed. The reaction mixture was filtered through Celite® and washed with CH₂Cl₂. Removal of the solvent gave a red/orange product mixture.

### 8. Synthesis of tris(4-tert-butylphenyl)methylium altebate

A schlenk flask was charged with 50 mg (0.10 mmol) of 4,4′,4″-tris(tert-butylphenyl)chloromethane dissolved in 5 mL of CH₂Cl₂. Subsequently, a solution of 110 mg (0.10 mmol) of sodium bis(3,3′,5,5′-tetra-tert-butyl-2,2′-diphenolato)aluminate(III).1THF in 5 mL of CH₂Cl₂ was added. An immediate color change from colourless to red/orange was observed. The reaction mixture was filtered through Celite® and washed with CH₂Cl₂. Removal of the solvent gave red/orange crystals.

¹H NMR (CD₂Cl₂, 500.13 MHz) δ_{H} (ppm)=7.91 (d, ³J_{H,H}=8.0 Hz), 7.63 (d, ³J_{H,H}=8.0 Hz), 7.46 (s), 7.37 (d, ⁴J_{H-H}=8.0 Hz), 7.15 (d, ⁴J_{H,H}=8.0 Hz), 7.13 (s), 1.58 (s), 1.53 (s), 1.51 (s), 1.39 (s), 1.36 (s), 1.32 (s); ¹³C(¹H} NMR (CD₂Cl₂, 125.76 MHz) δ_{c} (ppm)=204.2, 169.6, 153.3, 150.2, 149.4, 143.5, 142.2, 141.8, 141.4, 140.4, 138.9, 137.7, 136.8, 132.2, 131.4, 131.2, 130.0, 129.8, 129.7, 129.2, 129.0, 128.9, 128.6, 128.3, 127.8, 126.9, 125.8, 125.5, 125.2, 125.0, 124.8, 124.5, 123.4, 123.2, 123.0, 56.0, 37.2, 35.8, 35.5, 34.7, 34.7, 34.6, 34.5, 31.9, 31.8, 31.6, 31.5, 31.3, 30.9, 30.6, 30.3, 30.1, 29.9.

### 9. Synthesis of 1,3-bis(2,6-dilsopropylphenyl)imidazolin-2-ylidene-(dimethylsulfide)gold(I) altebate

Under inert gas conditions, 50 mg (0.08 mmol) of 1,3-bis(2,6-diisopropylphenyl)imidazolin-2-ylidenegold(I) chloride and 0.1 mL of dimethyl sulfide were dissolved in 5 mL of absolute CH₂Cl₂. In a separate schlenk flask, 83.5 mg (0.09 mmol) of sodium bis(3,3′,5,5′-tetra-tert-butyl2,2′-diphenolato)aluminate(III).THF were dissolved in 3 mL of CH₂Cl₂. After combination of the two solutions, a colourless powder precipitated out. The reaction mixture was stirred for a further 30 min and filtered through Celite®. Removal of the solvent gave a colourless crude product. After recrystallization from CH₂Cl₂/pentane, 77 mg (0.05 mmol, 67%) of colourless crystals were obtained.

¹H NMR (CD₂Cl₂, 300.13 MHz) δ_{H} (ppm)=7.53 (t, 2H, ³J_{H,H}=7.8 Hz), 7.35 (d, 4H, ³J_{H,H}=7.8 Hz), 7.20 (s, 2H), 7.21 (s, 2H), 7.01 (s, 2H), 7.02 (s, 2H), 4.21 (s, 4H), 3.06 (m, 4H), 2.11 (s, 6H), 0.90-1.55 (m, 113H); ¹³C{¹H} NMR (CD₂Cl₂, 75.48 MHz) δ_{c} (ppm)=198.0, 156.0, 147.1, 138.8, 138.7, 132.5, 131.1, 128.0, 125.3, 122.2, 35.4, 34.4, 32.0, 30.5, 29.4, 25.6, 24.2, 22.7, 14.2; IR (KBr): □ (cm⁻¹)=3400, 2960, 2906, 2868, 1630, 1495, 1462, 1433, 1405, 1387, 1360, 1325, 1278, 1243, 1201, 1132, 1101, 874, 804, 783, 763; decomposition: 220-250° C.; anal. calculated (%) for C₈₅H₁₂₄AlAuN₂O₄S: C 68.34; H 8.37; N 1.88; found: C 66.79; H 8.24, N 1.81 (contains CH₂Cl₂) C 66.10; H 8.13; N 1.84; (contains ⅔ CH₂Cl₂); MS (ESI+) m/z (%): 649.51 (100), 650.51 (28), 651.30 (3) [M−C₅₆H₈₀AlO₄]⁺, (ESI−) m/z (%): 843.59 (100), 844.59 (65), 845.59 (18) [M−C₂₉H₄₄AuN₂S]⁻.

### 10. Synthesis of Li(thf)₄ bortebate/lithium bis(3,3′,5,5′-tetra-tert-butyl-2,2′-diphenolato)borate(III)

A schlenk flask was charged under inert gas conditions with 6.1 mL (12 mmol) of a solution of lithium borohydride (2 M in THF) and an additional 15 mL of THF. Subsequently, a solution of 10 g (24 mmol) of 3,3′,5,5′-tetra-tert-butyl-2,2′-biphenol in 15 mL of THF was added gradually. The reaction mixture was heated to boiling under reflux for six days. Removal of the solvent gave a colourless product. After recrystallization from pentane, 8.7 g (7.8 mmol, 65%) of colourless powder were obtained.

¹H NMR (d₆-acetone, 500.13 MHz) δ_{H}=7.13 (d, 4H, ⁴J_{H,H}=2.5 Hz), 7.02 (d, 4H, ⁴J_{H,H}=2.5 Hz), 3.63 (m, 16H), 1.79 (m, 16H), 1.31 (s, 36H), 1.24 (s, 36H) ppm. ¹³C{¹H} NMR (d₆-acetone, 125.77 MHz) δ_{c}=155.9, 139.4, 139.2, 133.6, 126.0, 121.8, 68.1, 35.7, 34.6, 32.3, 31.7, 26.2 ppm. ¹¹B {1H} NMR (d₆-acetone,m 64.14 MHz) δ_{B}=6.45 (s) ppm. m.p. 241° C. IR (KBr): □ (cm⁻¹)=3426, 2959, 2904, 2870, 1637, 1476, 1435, 1411, 1389, 1360, 1282, 1267, 1242, 1102, 1048, 974, 935, 912, 878. (%) for C₅₆H₈₀BLiO₄ 4.THF (1123.41): calcd.: C 76.98, H 10.05. found: C 77.23, H 9.84. HR-MS (ESI−) m/z (%): calcd.: 827.61497 found: 827.61309 (100). [M-Li(thf)₄⁺]⁻.

1. An anion with the general structure (I): 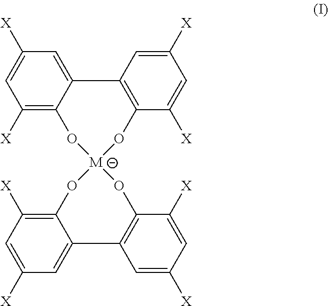
where
M is selected from the group consisting of Al, B, Ga, Sc, Y and the lanthanoids,
X is a substituent selected independently from the group consisting of aryl, —SiR¹¹R¹²R¹³ and substituents with the following general structure (II-A) or (II-B): 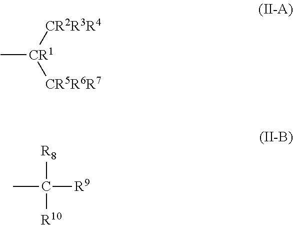
where R¹, R², R³, R⁴, R⁵, R⁶ and R⁷ are each independently selected from the group consisting of hydrogen, straight- or branched-chain C₁₋₁₂-alkyl, phenyl and benzyl, and R⁸, R⁹ and R¹⁰ are each independently selected from the group consisting of straight- or branched-chain C₁₋₂₆-alkyl, phenyl and benzyl, and where R¹¹, R¹² and R¹³ are each independently selected from the group consisting of aryl and straight- or branched-chain C₁₋₂₆-alkyl.

2. An anion as claimed in claim 1, where M is aluminum or boron.

3. An anion as claimed in claim 1, where X is a substituent with the general structure (II-B) where R⁸, R⁹ and R¹⁰ are each independently selected from a straight- or branched-chain C₁₋₂₆-alkyl radical.

4. An anion as claimed in claim 1, where X is a —CMe₃, —CEt₃, —CPr₃, —Ciso-Pr₃, —CBU₃, —Ciso-BU₃, —CMe₂C₁₅H₃₁, —CMe₂C₁₇H₃₃, —CMe₂C₁₇H₃₅, —CEt₂C₁₅H₃₁, —CEt₂C₁₇H₃₃, —CEt₂C₁₇H₃₅, —CBu₂C₁₅H₃₁, —CBu₂C₁₇H₃₃, —CBu₂C₁₇H₃₅ or a —CMe₂CH₂CMe₃ group.

5. An anion as claimed in claim 1 which has the following structure (III):

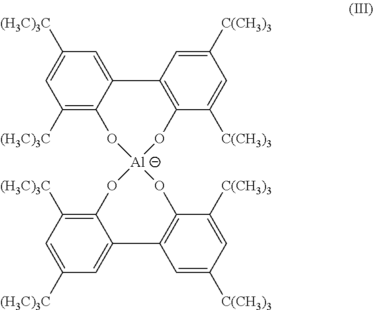

6. A compound comprising the anion as claimed in claim 1 and a cation.

7. A compound as claimed in claim 6, wherein the cation is selected from the group consisting of Li, Na, K, Rb, Cs, Mg, Ca, Sr, Ba, Sc, Y, La, Ti, Zr, V, Nb, Ta, Zn, Al, Ga, In, Ge and Bi, monosubstituted imidazolium derivatives, disubstituted imidazolium derivatives, trisubstituted imidazolium derivatives, pyridinium derivatives, pyrrolidinium derivatives, ammonium derivatives, phosphonium derivatives, guanidinium derivatives, isouronium derivatives, sulfonium derivatives.

8. A process for preparing the anion as claimed in claim 1, which comprises the steps of:
(a) the oxidative coupling of a substituted phenol of the general structure (IV) or the alkylation of 2,2′-biphenol (V) to give a substituted biphenol of the general structure (VI), and
(b) the reacting of the biphenol of the general structure (VI) with a mixed metal hydride, with elemental metal, with a metal alloy or by reaction with a base and a metal halide in order to form the anion with the general structure (I),
where M and X in the general structures (IV), (VI) and (I) are each as defined above:

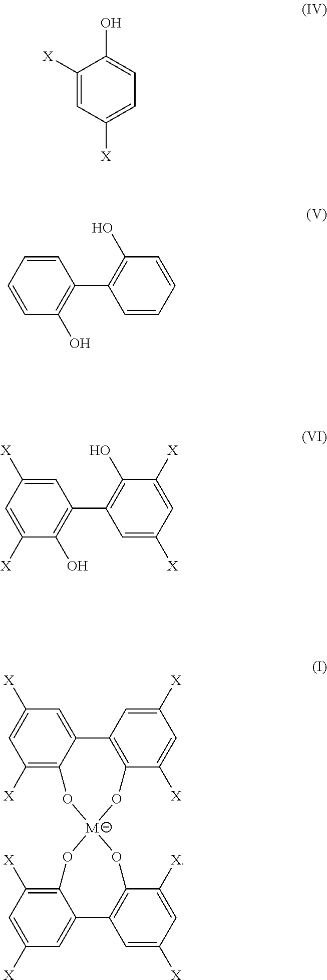

9. The process as claimed in claim 8, wherein the oxidative coupling is performed by means of MnO₂ under air.

10. The process of claim 8, wherein the compound with the general structure (VI) is reacted with LiAlH₄, NaAlH₄, NaBH₄ or LiBH₄ to form the anion of the general structure (I) where M is aluminum or boron.

11. The process of claim 8, wherein the reaction in step (b) is effected in THF or diethyl ether as the solvent, and the process, after step (b), further comprises the step of thermal removal of the THF or diethyl ether under reduced pressure.

12. The use of the anions of claim 1 as an ionic liquid, as an abstraction agent for halides or pseudohalides, as a crystallization promoter or stabilizer, as a superabsorbent for organic solvents, as a catalyst or cocatalyst, as a phase transfer catalyst, or for increasing the solubility of cations in organic solvents.
